(19) United States
(12) Patent Application Publication
(10) Pub. No.: US 2003/0030635 A1
(43) Pub. Date: Feb. 13, 2003

(54) Method, system and program for providing pathologic models and models obtained thereby

(75) Inventors: Hans-Peter Meinzer, Heidelberg (DE); Manuela Makabe, Dossenheim (DE); Matthias Thorn, Heidelberg (DE)

Correspondence Address: KALOW & SPRINGUT LLP, 488 MADISON AVENUE, 19TH FLOOR, NEW YORK, NY, 10022, US

(73) Assignee: Deutches Krebsforschungszentrum dkfz, Heidelberg (DE)

(21) Appl. No.: 10/167,542

(22) Filed: Jun. 11, 2002

(30) Foreign Application Priority Data
Jun. 12, 2001 (EP) 01 11 4253.6

(51) Int. Cl. G06T 15/00

(52) U.S. Cl. 345/419

(57) ABSTRACT

The present invention is directed to a method or system for reproducing a 3D object, in particular for modeling a pathologic preparation, with the following steps: providing picture data of the 3D object, such as of a pathological preparation, smoothing and/or equalizing the picture data so as to obtain modified picture data from the object with a minimum of deviations from the 3D object and transferring the resulting picture data to corresponding grid system data.

### FIELD OF THE INVENTION

The invention relates to methods, systems and programs for providing 3-dimensional (3D) pathological models and the models themselves.

### BACKGROUND OF THE INVENTION

The present invention relates to a method, a system and a program, for providing models, in particular 3D pathologic models, and to models obtained by such a method, a system and/or a program. More particularly, the invention concerns the conservation and reproduction of pathologic preparations or preparation collections.

### SUMMARY OF THE INVENTION

The invention comprises a method for reproducing a 3D object, comprising providing picture data of the 3D object, smoothing and/or equalizing the picture data so as to obtain modified picture data from the object with a minimum of deviations from the 3D object, and transferring the resulting picture data to corresponding grid system data.

The invention also comprises methods wherein the 3D object reproduced is a pathological preparation and methods wherein volumetric data is provided by means of one or more computerized tomography (CT) and/or magnetic resonance (MR) pictures. The invention comprises, prior to smoothing and/or equalizing, methods wherein regions of interest are segmented from the picture data, modified picture data is determined from the segmented regions, and the resulting picture data is transferred to corresponding grid system data. The invention also comprises methods wherein the corresponding grid system is a triangular grid system. The grid system data may be stored in a CA/CAM (STL) format. A model may be formed on the basis of the grid system data. The model may be formed, for example, by a laser sintering process.

The invention also comprises a system for reproducing a 3D object, comprising a means for providing picture data of the 3D object, a means for smoothing and/or equalizing the picture data so as to obtain modified picture data from the object with a minimum of deviations from the 3D object, and a means for transferring the resulting picture data to corresponding grid system data. The invention comprises such a system wherein the object is a pathological preparation.

The invention also comprises a computer program comprising code means for reproducing a 3D object in accordance with the invention. The invention further comprises a computer program product comprising program code means stored on a computer-readable medium for reproducing a 3D object. The invention also comprises a computer system for reproducing a 3D object in accordance with the invention. The computer system of the invention comprises means for reproducing a 3D object in accordance with the invention. The invention comprises systems that can be employed to reproduce or model a pathological preparation such as, for example, a rare congenital heart defect. The methods, programs, and systems of the invention can be employed for planning or preparing an operation, and can be employed for soft tissue engineering.

### BRIEF DESCRIPTION OF THE FIGURES

FIG. 1 illustrates, for a normal heart, an anterior view of a waxed heart specimen on the left and the laserlithographic reconstructed plastic model on the right.

FIG. 2 illustrates, for a normal heart, a 3D reconstructed computer model on the left. On the right, a cut through the 3D model shows the right atrium (RA), right ventricle (RV), left atrium (LA) and left ventricle (LV). Cuts in any plane can be interactively created using the Heidelberger Raytracing Technique. Depth perception is enhanced by the incorporation of shadows. MPA=main pulmonary artery; SVC=superior vena cava.

FIG. 3 illustrates Ebstein's anomaly. On the left side an endoluminal view into the right atrium (RA) was created to demonstrate the huge atrialized portion of the right ventricle. A cut through the right atrium (RA), right ventricle (RV) and left ventricle (LV) is shown on the right. The huge atrialized portion of the right ventricle (RA), the small right ventricular cavity (RV) and the extreme thin wall of the right ventricle (*) are visualized. A direct comparison with the normal heart (FIG. 2) is readily possible. Depth perception is enhanced by the incorporation of shadows. SVC=superior vena cava.

### DETAILED DESCRIPTION OF THE INVENTION

The present invention will now be described in connection with preferred embodiments. These embodiments are presented to aid in an understanding of the present invention and are not intended to, and should not be construed, to limit the invention in any way. All alternatives, modifications and equivalents that may become obvious to those of ordinary skill upon reading the disclosure are included within the spirit and scope of the present invention.

This disclosure is not a primer on preparing pathological models; basic concepts known to those skilled in the art or readily determinable have not been set forth in detail.

The present invention provides an improved method, system and/or program for providing pathologic models and/or to provide improved models obtained thereby.

The present invention provides a method or system for reproducing a 3-dimensional (3D) object, in particular for modeling a pathologic preparation, with the following steps: providing picture data of the 3D object, such as of a pathologic preparation, smoothing and/or equalizing the picture data so as to obtain modified picture data from the object with a minimum of deviations from the 3D object and transferring the resulting picture data to corresponding grid system data.

Preferably, the volumetric data is provided by means of one or more CT and/or magnetic resonance (MR) pictures. More preferably, regions of interest are segmented from the picture data and then the modified picture data is determined from the segmented regions and the resulting picture data from the segmented regions is transferred to corresponding grid system data. The picture data is then preferably transferred to a triangular grid system and the respective grid system data is stored in a CAD/CAM (STL) format.

After that a model can be formed on the basis of the grid system data by a laser sintering process.

The invention also concerns a computer program and a respective code means stored on a readable medium comprising program code means for performing the above described method when the program is run on a computer.

The subject matter according to the present invention achieves the advantages that the original pathologic preparations can be reproduced upon request in any given number with high precision and without any damage to the original. This is particularly of great value when the original pathologic samples are relatively rare. Moreover, the reproduced models are generally less sensitive to damage and easier to repair in case any unintended damage occurrs particularly in public institutions or universities. In addition to that, models with appropriate or the same dimensions or the same scale (1:1) as the originals can be provided easily.

The present invention can also be applied to any related field where there is a need for modeling 3D surfaces with high precision. Related fields are for example the preparation or planning of operations or the field of soft-tissue-engineering.

In a preferred embodiment the present invention comprises 3D computer modeling of rare congenital heart defects.

Having now generally described the invention, the same may be more readily understood through the following reference to the following examples, which are provided by way of illustration and are not intended to limit the spirit or scope of the present invention.

### EXAMPLE

The following example is intended to explain the invention further.

Precise knowledge of cardiac anatomy forms the basis for diagnosis and treatment of congenital heart disease (see reference 1). Only a few centers worldwide have access to specialized pathology collections of hearts with congenital malformations. Furthermore, rare specimens cannot be replaced after loss or damage. To preserve, reproduce, and publish the unique specimens of the Cardiac Registry, Children's Hospital Boston (CHB), for worldwide teaching and research purposes, a preferred embodiment of the present invention particularly adapted to model heart preparations comprises the following preferred steps.

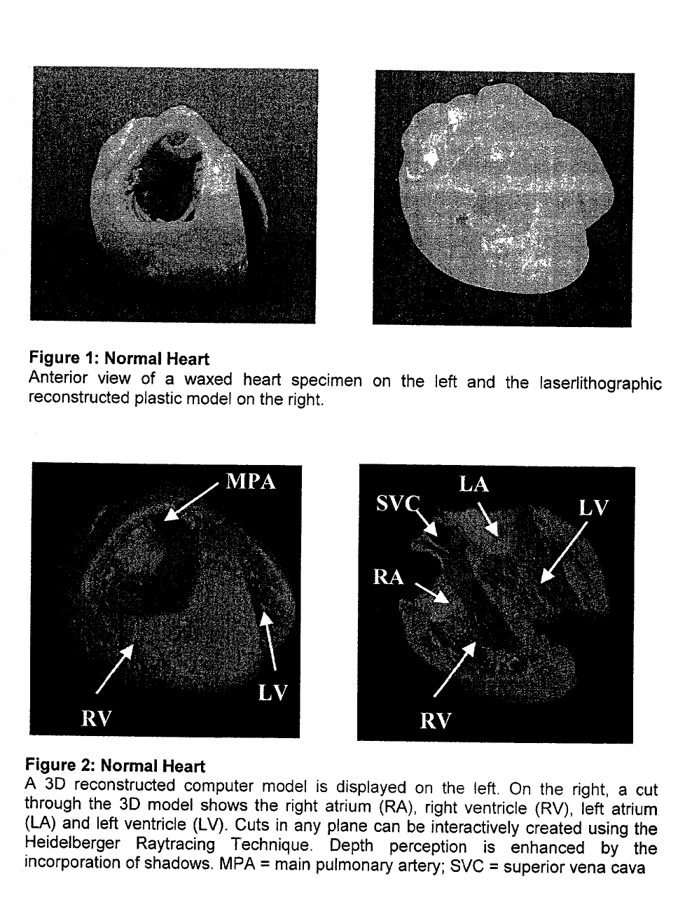

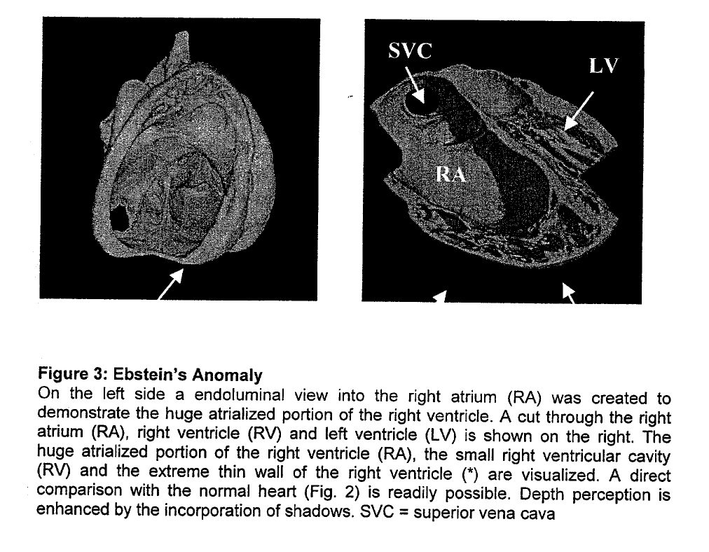

Waxed hearts of the Cardiac Registry, CHB, are selected (Table 1) and digitized using high resolution spiral Computer Tomography (pixel size 0.3 mm-0.4 mm). These digital data form the basis for a teaching tool: The digital data is used for generating high resolution 3D plastic copies of the original waxed heart (resolution <1 mm) using stereolithography (FIG. 1). Also 3D computer visualizations (FIGS. 2 and 3) are generated using the Heidelberger Raytracing Technique (see reference 2). This is a volume rendering method specifically designed for the needs of medical data visualization (see, http://mbi.dkfz-heidelbedrg.de/mbi). To enhance proper depth perception, shadows are incorporated in the 3D reconstructed models (FIGS. 2 and 3). A teaching CD-ROM can be developed combining 3D reconstructed heart models, text, audio- and video sequences.

The Heidelberger Raytracing Technique offers interactive 3D display in all spatial directions with endoluminal visualization of the atria, ventricles and great arteries (FIG. 3). A pixel size of 0.3 to 0.4 mm allows detailed reconstruction of the original waxed hearts (FIGS. 1 to 3). Cuts in any plane can be interactively reconstructed (FIGS. 2 and 3) and compared with other imaging techniques (echocardiography, magnetic resonance imaging, etc.). Pathologic abnormalities can readily be demonstrated and compared with the normal heart (FIGS. 2 and 3). Additional 3D effects were created on the computer screen using 3D red-green glasses.

A comparison of the original waxed hearts with the models obtained by the present invention by means of comparing the resulting CT pictures of the models with the ones from the original waxed hearts revealed a surprising precision of the present invention.

The major advantage of publishing this material in a digital medium, for example, on a CD-ROM, is the possibility of providing sequences of visualizations, e.g. “flights into the cavities”, or “slicing a heart” in any angle in space. These views are not possible with the original waxed hearts. Details can be zoomed, allowing accurate visualization of each anatomic detail. The combination of this image material with text, audio- and video sequences makes it a vital collection of knowledge, which cannot be provided by traditional book formats. Detailed spatial relationships of anatomic structures can be better demonstrated with very high-resolution stereolithographic reconstructed 3D plastic models (resolution <1 mm, FIG. 1).

The combination of both teaching tools enables interactive learning of the 3-dimensional appearance of congenital heart disease and provides an excellent substitute of the examination of actual heart specimens. An internet platform using this database could create a worldwide interactive learning and teaching center for the field of pediatric cardiac imaging.

Computer animated 3D visualization of selected cardiac specimens of congenital heart disease enables worldwide use for teaching and research. Constructed as a forum for pediatric cardiac imaging, participating institutions worldwide can contribute experience, clinical cases, and cardiac images of patients with congenital heart disease.

TABLE 1

| Segmental | |
|---|---|
| Anatomy | Diagnosis |
| {S, D, S} | Large membranous VSD with posterior extension |
| {S, D, S} | ASD I |
| {S, D, S} | Ebstein's anomaly, isolation of left atrial appendage |
| {S, D, S} | Mid-muscular VSD, pulmonary artery aneurysm with |
| | thrombus and calcification |
| {S, D, S} | Normal heart |
| {S, L, L} | Transposition of the great arteries, VSD, pulmonary vascular |
| | obstructive disease |

The segmental notation of the six cases are according to the approach described in references 3 and 4
VSD = ventricular septal defect; ASD I = atrial septal defect (primum type).

References:

1. Van Praagh R: Morphologic Anatomy, in Fyler, DC (ed): Nadas' Pediatric Cardiology, Philadelphia, Hanley & Belfus, Inc., 1992, 17-26.

2. H. P. Meinzer, K. Meetz, D. Scheppelmann, U. Engelmann, H. Baur: The Heidelberg Raytracing Model. IEEE Computer Graphics & Applications 11 (6): 34-43, 1991.

3. Van Praagh R: Segmental approach to diagnosis, in Fyler, DC (ed): Nadas' Pediatric Cardiology, Philadelphia, Hanley & Belfus, Inc., 1992, 27-35

4. Van Praagh R: Diagnosis of complex congenital heart disease: morphologic anatomic method and terminology. Cardiovasc Intervent Radiol 7:115, 1984

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

We claim:

1. A method for reproducing a 3D object, comprising:
(a) providing picture data of the 3D object;
(b) smoothing and/or equalizing the picture data so as to obtain modified picture data from the object with a minimum of deviations from the 3D object; and
(c) transferring the resulting picture data to corresponding grid system data.

2. A method according to claim 1, wherein the 3D object reproduced is a pathological preparation.

3. A method according to claim 1, wherein in step (a) volumetric data is provided by means of one or more CT and/or MR pictures.

4. A method according to claim 1, wherein prior to step (b) regions of interest are segmented from the picture data, modified picture data is determined from the segmented regions, and the resulting picture data is transferred to corresponding grid system data.

5. A method according to claim 1, wherein in step (c) the corresponding grid system is a triangular grid system.

6. A method according to claim 1, further comprising after step (c) storing the grid system data in a CA/CAM (STL) format.

7. A method according to claim 1, further comprising after step (c) forming a model on the basis of the grid system data.

8. A method according to claim 7, wherein the model is formed by a laser sintering process.

9. A system for reproducing a 3D object, comprising:
(a) a means for providing picture data of the 3D object;
(b) a means for smoothing and/or equalizing the picture data so as to obtain modified picture data from the object with a minimum of deviations from the 3D object; and
(c) a means for transferring the resulting picture data to corresponding grid system data.

10. A system according to claim 9, wherein the object is a pathological preparation.

11. A computer program comprising code means for performing the method of claim 1.

12. A computer program product comprising program code means stored on a computer readable medium for performing the method of claim 1.

13. A computer system for performing the method of claim 1.

14. A computer system according to claim 13, wherein the system comprises means for carrying out the method of claim 1.

15. A method according to claim 13, wherein the method is employed to reproduce or model a pathologic preparation.

16. A method according to claim 13, wherein the pathologic preparation is of a rare congenital heart defect.

17. A method according to claim 13, wherein the method is employed for planning or preparing an operation.

18. A method according to claim 13, wherein the method is employed for soft tissue-engineering.

19. A method according to claim 9, wherein the method is employed for reproducing or modeling a pathologic preparation such as a rare congenital heart defect.

20. A method according to claim 19, wherein the method is employed for planning or preparing an operation.

21. A method according to claim 19, wherein the system is employed for soft tissue-engineering.
